(19) United States
(12) Patent Application Publication
(10) Pub. No.: US 2009/0119198 A1
(43) Pub. Date: May 7, 2009

(54) Method for Domain Trading

(76) Inventors: Gregory Manriquez, Washington, DC (US); Stevan Lieberman, Washington, DC (US)

Correspondence Address: GREENBERG & LIEBERMAN, LLC, 2141 WISCONSIN AVE, N.W., SUITE C-2, WASHINGTON, DC, 20007, US

(21) Appl. No.: 12/266,363

(22) Filed: Nov. 6, 2008

Related U.S. Application Data
(60) Provisional application No. 60/985,677, filed on Nov. 6, 2007.

(51) Int. Cl. G06Q 40/00

(52) U.S. Cl. 705/37

(57) ABSTRACT

A method for domain portfolio trading involving the assessment of risk level based on various tangible criteria and applying this determination to the assignment of a value. Once the aggregated level of risk and actual value number are determined, a real-time, online domain portfolio trading mechanism allows those involved to track, move, implement and otherwise conduct business in an instantaneous environment.

This is a non-provisional application claiming priority to provisional patent application number 60/985,677 filed on Nov. 6, 2008.

### FIELD OF THE INVENTION

The present method involves taking various risk criteria relating to domain names and assigning a value in order to engage in real-time domain portfolio trading, tracking and implementation in an online environment.

### BACKGROUND OF THE INVENTION

The domain industry has grown exponentially along with the development of the Internet. Entire industries, businesses and rules have sprouted as people sought to cash in on the millions of domains. This domain boom has created a number of avenues for people to buy, sell and trade domains as if they were traditional assets. However, the financial aspect of transferring domain assets typically does not go beyond the more traditional methods of business. This means that such methods more associated with stock trading—such as risk and associated value—has not made significant inroads into the domain industry. As a result, there remains a need for a method that assigns value to domains after dividing domains into various levels of risk. In addition, since domains are inherently online assets, there remains a need for real-time trading of these portfolios. The present method satisfies this need by aggregating domains into various levels of risk-oriented portfolios and implementing real-time online trading based on additional criteria such as portfolio testing, bonuses and instant domain transfers.

The present invention is a way to bring reliable value to domain names consistent with real estate holdings, earnings to establish a basis for loans, and many other avenues to Currently, there is no recognized way to assign reliable data in terms of business and the use and holding of domain names and domain name portfolios. The present invention satisfies this need by providing a method by which a financial institution can rely on the value of domain names so that domain names can be used for such transactions as bonds, loans and collateral.

Traditionally, banks will value such items as earnings or real property assessments/comparable sales where value can be assigned. But banks will not consider high-traffic areas because they are based on assumptions among other items. However, in the domain name industry, high-traffic domain names do possess an inherent value. The present invention works to place a value on such aspects of domain names so that these domain names and domain name portfolios can be used in a wider array of traditional business, banking and credit dealings.

### SUMMARY OF THE INVENTION

The present method relates to domain portfolio trading in a real-time online environment. The present method combines the valuation of domains into a value and then ingratiates the value into a technical online format. Importantly, it should be noted that the amount of potential customers or traffic to the domain name makes a difference in terms of valuation according to the present invention.

Relating to the domain valuation aspect of the present method, domains will be aggregated into various levels of risk. In the preferred embodiment of the present method, domains portfolios will be divided into high, medium and low risk categories. It is foreseen that additional risk levels for these domain portfolios also may be included.

### Risk Criteria

The risk levels are based on a number of criteria and factors.
For example, the number of domains in a portfolio carries a relative risk one way or the other. So the number of domains in a portfolio would be one bit of information that would be analyzed into the overall risk assessment.
Domain TLD also would be included because each TLD assumes risks based on specific legal jurisdictions and countries.
Source of traffic is an obvious risk as it relates to such elements as type-in, search engine and back link.
Origin of traffic relates to specific global locations of user-generated views.
Domain Industry specification relates to the domain asset corresponding with an industry category, such as Health, Legal, Relationships, etc.
Quality of domain name relating to full word or mistype.
Pay per click performance relates to risk as a test of PPC “health” over historical time frame is an important risk indicator.
Domain performance and monthly yield includes the historic RPM performance of the domain as well as revenue measure per thousand views or some other measuring method.
Industry sales of similar domains.

### Valuation

Once the relative risk has been determined through the above criteria, an actual value number is associated to the domain assets. This element of the present method is conducted through the analysis of monthly revenue generation and estimated monthly growth.

These domain aggregations will then be given 6 month, 12 month, 18 month and 24-month valuations. The owners of the domains also will be given loans based on this amount. However, the loan can be distributed to a secondary market for public trading. The loan will take the form of a bond issuance with an associated yield. This yield will be payable monthly. Face value of the bond will be a certain dollar amount, such as 110 dollars, upon redemption. Redemption occurs specified increments such as in 6-month increments.

### Online Trading Environment

After the risk and valuations relating to domain portfolios have been determined, the next step in the present method involves the online trading aspect. A real time online trading environment is established for the trading of domain portfolio assets. The method focuses first on the “testing” of a portfolio. The “testing” aspect is where the above criteria will be closely watched and calculated. Once a testing period such as 2 months has been completed, a loan will be made on valuation to the domain portfolio owner. This owner will escrow domains and corresponding assets as collateral for the issuance of a bond. An intermediary party will have sole and exclusive rights to purchase and distribute these bonds. The domain portfolios themselves will be open ended with the portfolio owner, who will be contractually obliged to add/remove domains from the established portfolio only under the certain circumstances. These circumstances include a desire to boost the value of the portfolio for whatever reason and also to remove domains only after other domains of equal or greater value have been placed in the portfolio (requires an additional amount of time such as 2 months of testing of those domains).

Meanwhile, the online environment possesses a number of services and characterizations that cater to the traders involved with the domain portfolios. This online trading platform includes the following services.
Individual accounts with username and password access.
A means to add or retrieve cash from deposit in a bank account or holding account for the immediate purchase of domain portfolio bonds.
The real time tracking of price changes based on “last” traded information.
Limit trading capabilities where a sale or purchase price can be pre-set on the system for immediate action by the system.
The instantaneous completion of share ownership transfer.
Margin trading is available to clients with large deposits and time on the system.
Loyalty bonuses will be enacted for long time users.
A derivatives market will be created to anticipate increases or decreases in market factors.

In addition to the above services, various technical implementations also are available in the preferred embodiment of the present method. For example, a bid/ask system may be used where shares can be sold or purchased by users on the system once a price is agreed upon. Moreover, the last price will be recorded in real-time. Each domain also will have a correlating domain exchange (DOMEX) figure

### Real-Time Valuation

The DOMEX is an element of the present method relating to the real time trend of tracking domain valuation. DOMEX takes into account a number of factors for valuation.
Domain category marking meaning that each domain is given a particular category and corresponding sub category for identification.
Real time prices category and subcategory keywords and associated and similar keywords. These keywords are on search engines and other known distributors of keyword sales. These keywords also may have corresponding language components.
Origin and amount of user traffic to the domain is valued based on geographic region, advertising 1 click conversion, advertising 2 click conversion and advertiser completion conversion.
Rating will be applied to each domain as an indicator for value and speculation.

### BRIEF DESCRIPTION OF THE PRESENT METHOD

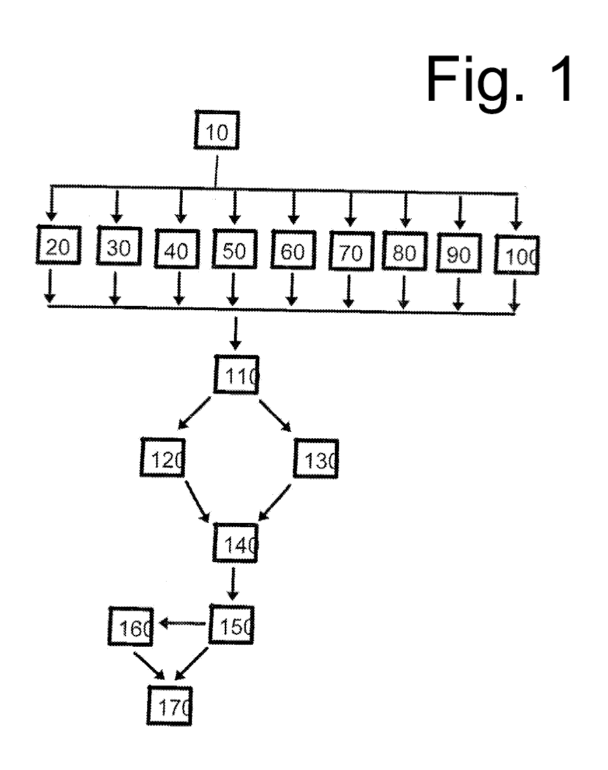

FIG. 1 is a flow chart detailing the risk and value determinations of the present method.

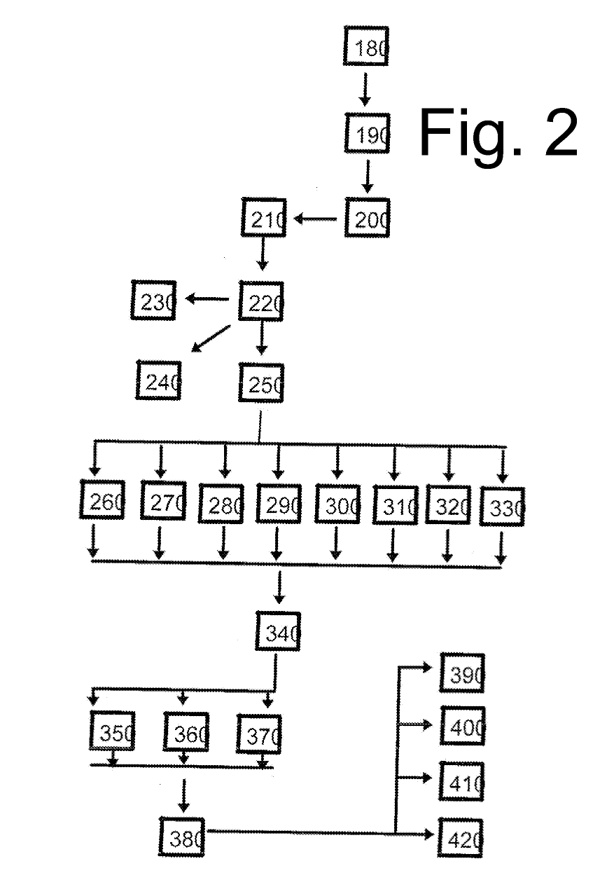

FIG. 2 is a flow chart detailing the online trading aspect of the present method.

### DETAILED DESCRIPTION OF THE PRESENT METHOD

The present method relates to domain portfolio trading in a real-time online environment. The present method combines the valuation of domains into a value and then integrates the value into a technical online format. FIG. 1 shows us a flow chart detailing the various steps taken in the present method relating to the more business-related aspects. These business aspects involve the valuation and risk-level determinations as opposed to the technical, online trading elements as described by FIG. 2.

Relating to the domain valuation aspect of the present method, FIG. 1 shows us the steps taken for domains to be aggregated into various levels of risk. In the preferred embodiment of the present method, domains portfolios will be divided into high, medium and low risk categories. It is foreseen that additional risk levels for these domain portfolios also may be included.

### Risk Criteria

The risk levels are based on a number of criteria and factors. The first step is to begin the analysis process (10). The analysis process (10) then takes in numerous factors into determining the level of risk for a domain portfolio as seen in FIG. 1.
For example, the number of domains (20) in a portfolio carries a relative risk one way or the other. So the number of domains in a portfolio would be one bit of information that would be analyzed into the overall risk assessment. Any risk assessment in the preferred embodiment will be assigned a number and this number will be published online.
Domain TLD (30) also would be included because each TLD assumes risks based on specific legal jurisdictions and countries. The changing legal factors, i.e. domain loss in particular tld's, rule changes in different countries, among other factors will be available for review online in the preferred embodiment.
Source of traffic (40) is an obvious risk as it relates to such elements as type-in, search engine and back link.
Origin of traffic (50) relates to specific global locations of user-generated views. The origin of the traffic will be shown online as well along with the associated time and income levels being cross indexed.
Domain industry specification (60) relates to the domain asset corresponding with an industry category, such as Health, Legal, Relationships, etc.
Quality of domain name (70) relating to full word or mistype. A quality number will be published along with the basis for the assigned quality.
Pay per click performance (80) relates to risk as a test of PPC “health” over historical time frame is an important risk indicator.
Domain performance (90) and monthly yield includes the historic RPM performance of the domain as well as revenue measure per thousand views or some other measuring method.
Industry sales of similar domains (100).

It is understood that in the preferred embodiment of the present invention, all of the above factors will be available for an investor to review on a portfolio by portfolio basis. The ability for an investor to jump in and out of different portfolios in real time also is available. This will be pertinent to investors as different portfolios will perform better or worse at different times Examples include day, night, summer, winter, etc. The investors input or withdrawal money into portfolios and the entire DOMEX in real time will create and ebb and flow of valuation of portfolios making the use of the money by the portfolio owners more or less based on time and the real time—short term and long term—performance of portfolios, thus providing actual valuations based on not just what a particular person believes, but what the entire market believes.

### Valuation

Once the relative risk has been determined through the above criteria, FIG. 1 shows that the next step is to determine an actual value number associated to the domain assets (110). This element of the present method is conducted through the analysis of monthly revenue generation (120) and estimated monthly growth (130).

These domain aggregations will then be given monthly valuations (140). In the preferred embodiment of the present method, these monthly valuations (140) may be 6 month, 12 month, 18 month and 24-month valuations. These valuations will be done by domain experts, however, the valuation will more often then not be a percentage of the floating valuation as described above. The owners of the domains also will have loans (150) based on this amount made available to them. However, the loan can be distributed to a secondary market (160) for public trading. The loan will take the form of a bond issuance with an associated yield. This yield will be payable monthly. Face value of the bond will be a certain dollar amount, such as 110 dollars, upon redemption. Redemption (170) occurs specified increments such as in 6-month increments.

### Online Trading Environment

FIG. 2 shows us the online, real-time trading mechanism of the present method. The online aspects of the present method are ingrained in known online and interactive technology. After the risk and valuations relating to domain portfolios have been determined, the next step in the present method involves the online trading aspect. A real time online trading environment is established for the trading of domain portfolio assets. The method focuses first on the “testing” (180) of a portfolio. The “testing” (180) aspect is where the above criteria will be closely watched and calculated. Once a testing period such as 2 months has been completed, an additional loan (190) may be made on valuation to the domain portfolio owner. This owner will escrow (200) domains and corresponding assets as collateral for the issuance of a bond. An intermediary party (210) will have sole and exclusive rights to purchase and distribute these bonds. The domain portfolios themselves will be open ended with the portfolio owner, who will be contractually obliged (220) to add/remove domains from the established portfolio only under the certain circumstances. These circumstances as seen in FIG. 2 include a desire to boost the value of the portfolio (230) for whatever reason and also to remove domains (240) only after other domains of equal or greater value have been placed in the portfolio (requires an additional amount of time such as 2 months of testing of those domains).

Meanwhile, the online environment possesses a number of services (250) and characterizations that cater to the traders involved with the domain portfolios. This online trading platform includes the following services (250) that must be taken into account.
Individual accounts with username and password access (260).
A means to add or retrieve cash from deposit in a bank account or holding account for the immediate purchase of domain portfolio bonds (270).
The real time tracking of price changes based on “last” traded information (280).
Limit trading capabilities where a sale or purchase price can be pre-set on the system for immediate action by the system (290).
The instantaneous completion of share ownership transfer (300).
Margin trading is available to clients with large deposits and time on the system (310).
Loyalty bonuses will be enacted for long time users (320).
A derivatives market will be created to anticipate increases or decreases in market factors (330).

In addition to the above services, various technical implementations (340) also are available in the preferred embodiment of the present method. For example, a bid/ask system (350) may be used where shares can be sold or purchased by users on the system once a price is agreed upon. Moreover, the last price will be recorded in real-time (360). Each domain also will have a correlating domain exchange (DOMEX) figure (370).

### Real-Time Valuation

The DOMEX is an element of the present method relating to the real time trend of tracking domain valuation. DOMEX takes into account a number of factors for valuation. The real-time element (380) is important for instantaneous results.
Domain category marking (390) meaning that each domain is given a particular category and corresponding sub category for identification.
Real time prices category and subcategory keywords and associated and similar keywords (400). These keywords are on search engines and other known distributors of keyword sales. These keywords also may have corresponding language components.
Origin and amount of user traffic to the domain (410) is valued based on geographic region, advertising 1 click conversion, advertising 2 click conversion and advertiser completion conversion.
Rating will be applied to each domain as an indicator for value and speculation (420).

All of the above systems are seen as being not technically hard to implement. In addition, all of the above listed factors will be implemented in a database. A mysql system is envisioned in the preferred embodiment, however there are a number of other formats which would be equally capable. The database would be segregated into the smallest possible factors allowing for cross-indexing of any different factor. The front end of the system would be implemented primarily via a web server and depending on the accessing person's authority, more or less data could be accessed. Data changes would be implemented in real time, as they are made accessible to the system. The front end would be able to generate cross indexing for the users based on pre-setup templates and more advanced users would be able to add in additional factors as they choose. The data will be available not only in spreadsheet format, but also in standard graphs as known. Data input on buys and sells, investments taken and repaid, Web page implementation, among other factors would be available in the system for the users. Webpage implementation of sites would be fed into the system in real time through the use of cookies that would count the usual web page factors and transmitting this information to the system via the Internet.

Investors will have the ability to blend their investments over multiple portfolios with a single investment by simply clicking on radio boxes when logged in to their account. The system will accept incoming payments for such investments in any method available, including, but not limited to, check, credit card, PAYPAL™, GOOGLE™ check out, Pay me later, as well as any other method that becomes available. Withdrawal of money will be done via a similar method. It should be emphasized that the use of primarily electronic means will be preferred and there will be surcharges for the use of non-electronic methods.

It is contemplated that the entire system will be run out of a computing cloud, however it is equally viable to implement off standard web servers.

Moreover, the users of the present invention also can be automatically joined to new accounts of domain name holdings (also herein referred to as domain name portfolios); and further the users of the present invention can have their financial account (debit, credit card, balance deposited with the present invention) debited automatically when joining automatically occurs. In the preferred embodiment, the users of the present invention also will have the ability to evaluate domain name portfolios (based on traffic, and other measures described previously herein) to statistically evaluate performance in real time—as opposed to quarterly reports that are issued by companies traded in worldwide markets.

We claim:

1. A method for domain name trading, comprising:
dividing domain name portfolio into risk categories;
analyzing factors to determine level of risk for the domain name portfolio;
determining an actual value number associated to domain assets within the domain name portfolio;
giving domain aggregations monthly valuations;
providing loans based on the monthly valuations;
testing the domain name portfolio by watching and calculating the factors;
providing an additional loan after a testing period, the additional loan made on valuation to an owner of the domain name portfolio;
placing the domain name assets in escrow as collateral for issuance of a bond;
obliging the owner to add/remove the domain names from the domain name portfolio only under certain circumstances;
implementing services and characterizations to an online trading platform; and
tracking domain valuation by correlating a domain exchange figure with the domain name, the domain exchange figure taking into account factors for valuation.

2. The method for domain name trading of claim 1, further comprising determining an actual value number associated to domain assets within the domain name portfolio by analyzing monthly revenue generation and estimated monthly growth.

3. The method for domain name trading of claim 1, further comprising giving domain aggregations monthly valuations in increments of between 6 months and 24 months.

4. The method for domain name trading of claim 1, further comprising providing loans based on the monthly valuations, the loans taking the form of a bond issuance with an associated yield.

5. The method for domain name trading of claim 4, further comprising paying the associated yield monthly.

6. The method for domain name trading of claim 5, further comprising monetizing a face value of the bond issuance at a certain dollar amount upon redemption.

7. The method for domain name trading of claim 6, further comprising redeeming the bond issuance in specified increments.

8. The method for domain name trading of claim 1, further comprising limiting sole and exclusive rights to purchase and distribute the bond to an intermediary party.

9. The method for domain name trading of claim 1, further comprising obliging the owner to add/remove the domain names from the domain name portfolio only under certain circumstances, the certain conditions being a desire to boost the value of the domain name portfolio.

10. The method for domain name trading of claim 1, further comprising obliging the owner to add/remove the domain names from the domain name portfolio only under certain circumstances, the certain conditions being a desire to remove the domain name only after other domain names of equal or greater value have been placed into the domain name portfolio.

11. The method for domain name trading of claim 1, further comprising implementing services and characterizations to an online trading platform, the services being individual accounts with username and password access, a means to add or retrieve cash from deposit in a bank account or holding account for the immediate purchase of the bonds, real time tracking of price changes based on “last” traded information, limit trading capabilities where a sale or purchase price can be pre-set for immediate action, instantaneous completion of share ownership transfer, margin trading to clients with large deposits and invested time, loyalty bonuses for long time users, and a derivatives market to anticipate increases or decreases in market factors.

12. The method for domain name trading of claim 11, further comprising implementing services and characterizations to an online trading platform, the services being a bid/ask system where shares can be sold or purchased once a price is agreed upon.

13. The method for domain name trading claim 12, further comprising recording a last price in real-time.

14. The method for domain name trading of claim 1, further comprising tracking domain valuation by correlating the domain exchange figure with the domain name, the domain exchange figure taking into account factors for valuation being domain category marking, real time prices category and subcategory keywords, origin and amount of user traffic to the domain name values based on geographic region, advertising 1 click conversion, advertising 2 click conversion and advertiser completion conversion, and applying rating to each of the domain names as an indicator for value and speculation.

15. The method of domain name trading of claim 14, further comprising implementing tracking valuation of the domain names in real time through a database.

16. The method of domain name trading of claim 1, further comprising combining a valuation of the domain name into a value and then integrates the value into a technical online format.
